(19) United States
(12) Patent Application Publication
(10) Pub. No.: US 2026/0073917 A1
(43) Pub. Date: Mar. 12, 2026

(54) Computer System and Non-Transitory Computer-Readable Storage Medium

(71) Applicant: Hitachi Solutions, Ltd., Tokyo (JP)

(72) Inventors: Yuxin LIANG, Tokyo (JP); Nao HOTTA, Tokyo (JP); Takeshi TANAKA, Tokyo (JP); Naoya ISHIDA, Tokyo (JP); Hideto YAMAMOTO, Tokyo (JP); Toshihiro KUJIRAI, Tokyo (JP); Masaki HAMAMOTO, Tokyo (JP); Masashi EGI, Tokyo (JP); Masayoshi MASE, Tokyo (JP)

(21) Appl. No.: 19/047,717

(22) Filed: Feb. 7, 2025

(30) Foreign Application Priority Data
Sep. 9, 2024 (JP) 2024-154611

(51) Int. Cl. G10L 15/22; G10L 15/18

(52) U.S. Cl. CPC G10L 15/22; G10L 15/18

(57) ABSTRACT

In order to flexibly present an additional question in response to an answer from a user, a computer system outputs output data for presenting a first question to a user, sequentially receives first stream data including an answer to the first question from the user, executes speculative execution processing for question candidate generation at least one time during reception of the first stream data, generates a second question based on a question candidate generated by the speculative execution processing for first question candidate generation when input of the answer to the first question is ended, and outputs output data for presenting the second question to the user. In the speculative execution processing for the question candidate generation, a prompt that causes a natural language processing program to execute generation of the question candidate in consideration of the answer included in the stream data received is generated, the prompt is input to the natural language processing program, and the question candidate generated by the natural language processing program is stored in a storage medium.

### CLAIM OF PRIORITY

The present application claims priority from Japanese patent application JP 2024-154611 filed on Sep. 9, 2024, the content of which is hereby incorporated by reference into this application.

### BACKGROUND OF THE INVENTION

### 1. Field of the Invention

The present invention relates to a system that conducts an interview.

### 2. Description of Related Art

JP 2023-937 A is a document that discloses a system for a user to conduct an interview. JP 2023-937 A discloses “In a pseudo-interview system 10 configured by connecting a terminal device 20 and a server device 30 over a network 11, the terminal device 20 includes: a collection unit 213 which records voice of a user who responds to a question in a pseudo-interview; a voice recognition unit 214 which converts voice data of the recorded voice of the user into text data; and a voice input/output unit 24 and a display unit 25 which output a question to the user or output assessment information for the user. The server device 30 includes: an analysis unit 312 for analyzing the voice data of the user and the text data; a question determination unit 311 which determines a next question corresponding to the previous question, on the basis of, a result analyzed by the analysis unit; and an assessment unit 314 which generates assessment information for the user on the basis of, the result analyzed by the analysis unit 312.”

In JP 2023-937 A, as disclosed in paragraph [0080] that “With reference to the question DB 321 in the storage unit 32, one question list other than the question list previously selected for the user is randomly selected from the question list group corresponding to the course and the level of the pseudo-interview transmitted from the terminal device 20 in step S2, and the first question is determined based on the selected question list”, a question selected from the question list is employed for question generation.

### CITATION LIST

### Patent Literature

Patent Literature 1: JP 2023-937 A

### SUMMARY OF THE INVENTION

Since the technique disclosed in Patent Literature 1 uses a question existing in a question list, there is room for improvement in the flexibility of a question to be generated.

### Solution to Problem

A representative example of the invention disclosed in the present application is as follows. That is, a computer system including a processor and a storage medium connected to the processor. The processor outputs output data for presenting a first question to a user, sequentially receives first stream data including an answer to the first question from the user, executes speculative execution processing for first question candidate generation at least one time during reception of the first stream data, generates a second question based on at least one first question candidate generated by the speculative execution processing for the first question candidate generation when input of the answer to the first question is ended, outputs output data for presenting the second question to the user, generates, in the speculative execution processing for the first question candidate generation, a first prompt that causes a natural language processing program to execute generation of the first question candidate in consideration of the answer included in the first stream data received, inputs the first prompt to the natural language processing program, and stores the first question candidate generated by the natural language processing program in the storage medium.

### Advantageous Effects of Invention

According to the invention, an interview system can present a flexible additional question (the second question) in accordance with the answer to the first question. Problems, configurations, and effects other than those described above will be clarified by the following description of embodiments.

### BRIEF DESCRIPTION OF THE DRAWINGS

FIG. 1 is a diagram illustrating an example of a configuration of a system of a first embodiment.

FIG. 2 is a diagram illustrating an example of a data structure of a conceivable question DB of the first embodiment.

FIG. 3 is a diagram illustrating an example of a data structure of a question candidate DB of the first embodiment.

FIG. 4A is a diagram illustrating an example of a UI of the first embodiment.

FIG. 4B is a diagram illustrating an example of the UI of the first embodiment.

FIG. 5 is a sequence diagram explaining a processing flow of the system of the first embodiment.

FIG. 6 is a flowchart explaining an example of processing executed by a voice extraction unit of the first embodiment.

FIG. 7 is a flowchart explaining an example of processing executed by a question generation unit of the first embodiment.

FIG. 8 is a flowchart explaining an example of processing executed by a question selection unit of the first embodiment.

FIG. 9 is a flowchart explaining an example of question candidate monitoring processing executed by the question selection unit of the first embodiment.

FIG. 10 is a flowchart explaining an example of additional question selection processing executed by the question selection unit of the first embodiment.

FIG. 11 is a flowchart explaining an example of processing executed by a question generation unit of a second embodiment.

FIG. 12 is a flowchart explaining an example of question candidate monitoring processing executed by a question selection unit of the second embodiment.

FIG. 13 is a flowchart explaining an example of processing executed by a question generation unit of a third embodiment.

FIG. 14 is a flowchart explaining an example of additional question selection processing executed by a question selection unit of the third embodiment.

FIG. 15 is a diagram illustrating an example of a data structure of a question candidate DB of a fourth embodiment.

FIG. 16 is a flowchart explaining an example of processing executed by a question generation unit of the fourth embodiment.

FIG. 17 is a flowchart explaining an example of question candidate monitoring processing executed by a question selection unit of a fifth embodiment.

FIG. 18A is a flowchart explaining an example of additional question selection processing executed by a question selection unit of a sixth embodiment.

FIG. 18B is a flowchart explaining an example of additional question selection processing executed by the question selection unit of the sixth embodiment.

### DESCRIPTION OF EMBODIMENTS

Embodiments of the invention will be described below with reference to the accompanying drawings. However, the invention shall not be construed as being limited to the description of the embodiments below. It is easily understood by those skilled in the art that the specific configuration can be changed without departing from the idea or the gist of the invention.

In the configurations of the invention described below, the same or the similar components or functions are denoted by the same reference signs and duplicate explanations are omitted.

Examples of various types of information may be described by expressions such as “table”, “list”, and “queue”, but the various types of information may be expressed by data structures other than those above. For example, various types of information such as “XX table”, “XX list”, “XX queue” may be “XX information”. In describing identification information, expressions such as “identification information”, “identifier”, “name”, “ID”, and “number” are used, and they can be replaced with each other.

In the present specification, expressions such as “first”, “second”, and “third” are used to identify components and do not necessarily limit the number or the order of the components.

Positions, sizes, shapes, ranges, and the like in the drawings and the like do not necessarily indicate actual positions, sizes, shapes, ranges, and the like for the sake of facilitating the understanding of the invention. Therefore, in the invention, positions, sizes, shapes, ranges, and the like are not limited to those disclosed in the drawings and the like.

### First Embodiment

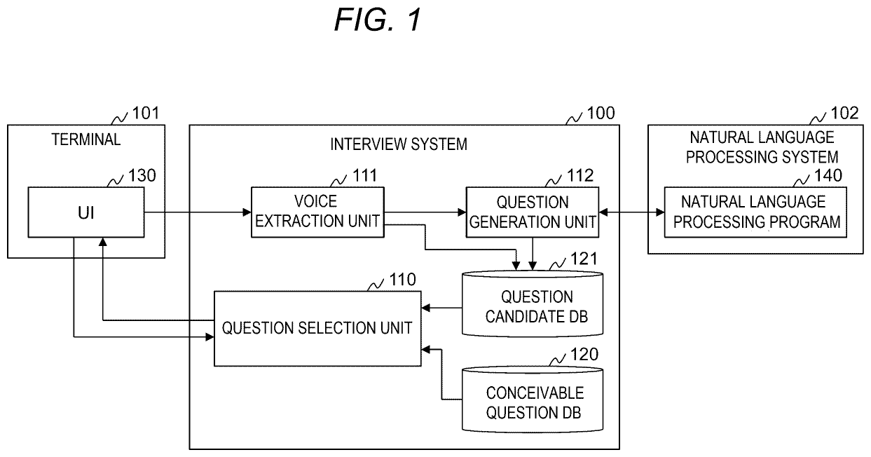

FIG. 1 is a diagram illustrating an example of a configuration of a system of the first embodiment.

The system is configured with an interview system 100, a terminal 101, and a natural language processing system 102. The interview system 100, the terminal 101, and the natural language processing system 102 are connected to each other via a network such as a local area network (LAN).

The terminal 101 is a terminal operated by a user, and is a general-purpose computer, a smartphone, or a tablet terminal, for example. The terminal 101 is provided with a UI 130 by the interview system 100. The UI 130 presents a question and transmits an answer to the question from a user to the interview system 100. As a method for presenting a question, displaying a text on a screen and outputting voice are conceivable. After input of the answer to the question by the user is ended, that is, when the end of speech is detected, the UI 130 transmits a speech end notification to a question selection unit 110. It should be noted that an answer may be input in a text format.

The natural language processing system 102 uses a natural language processing program 140 to execute various natural language processing tasks. The natural language processing program 140 receives a prompt including a content of a task such as a question described in a natural language, understands the content of the task, and generates and outputs an answer text.

As a use case of the system, practice of interview by a user, and conduct of a recruitment interview by a company are conceivable.

The interview system 100 is a system for conducting an interview, and configured with a computer including a processor, a storage medium such as a memory, and a communication interface. It should be noted that the interview system 100 may be configured using one computer. The interview system 100 includes the question selection unit 110, a voice extraction unit 111, and a question generation unit 112, and retains a conceivable question DB 120 and a question candidate DB 121. The question selection unit 110, the voice extraction unit 111, and the question generation unit 112 are implemented by the processor executing programs stored in the memory. It should be noted that a plurality of functional units may be consolidated into one, or a single functional unit may be divided into a plurality of functional units.

The programs may be installed via a network, or may be installed via a non-temporary computer readable medium which the computer can read.

The conceivable question DB 120 is a database that stores questions (conceivable questions) prepared in advance. The question candidate DB 121 is a database that stores additional question candidates generated by the natural language processing program 140. In the following description, when a conceivable question and an additional question are not distinguished from each other, each of them is referred to as a question.

The question selection unit 110 selects a conceivable question from the conceivable question DB 120, or selects an additional question from the question candidate DB 121, and sends the selected question to the UI 130 of the terminal 101. The UI 130 presents the question received.

The voice extraction unit 111 acquires stream data including the voice of a user via the UI 130. The stream data is video data or voice data. During input of an answer to the question (during reception of the stream data), the voice extraction unit 111 performs speculative execution processing in which the voice is extracted from the stream data received and converted into a text. It should be noted that “speculative execution” does not have a meaning of financial securities transactions, but refers to an optimization technique for a computer. The meaning thereof is “causing a computer to perform processing that may not be necessary” (excerpt from https://ja.wikipedia.org/wiki/%E6%8A%95%E6%A9%9F%E7%9A%84%E5%AE%9F%E8%A1%8C on Aug. 8, 2024), and “a computer system performs some task that may not be needed” (excerpt from https://en.wikipedia.org/wiki/Speculative_execution on Aug. 8, 2024).

During input of the answer to the question (during reception of the stream data), the question generation unit 112 performs speculative execution processing of generating a question candidate. Specifically, the question generation unit 112 generates a prompt including the text (answer) generated by the voice extraction unit 111 and instructing generation of an additional question in response to the answer of the user, and inputs the prompt to the natural language processing program 140. The question generation unit 112 stores the additional question generated by the natural language processing program 140 in the question candidate DB 121.

It should be noted that the configuration of the system illustrated in FIG. 1 is merely an example, and is not limited to the example. For example, the interview system 100 may include the natural language processing program 140.

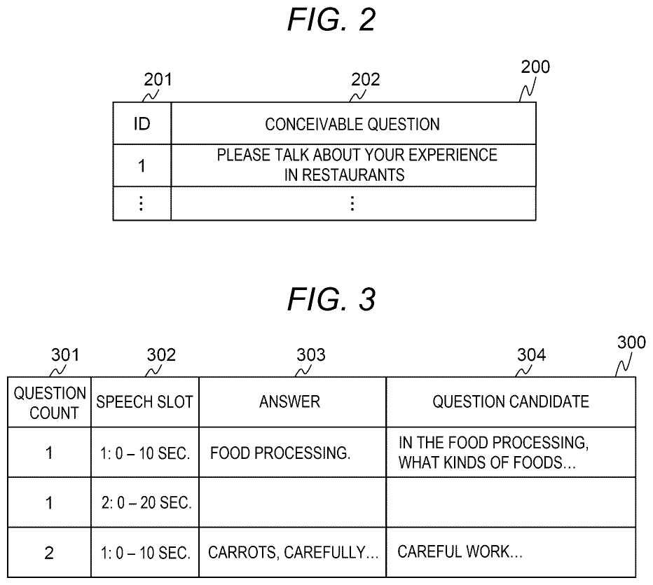

FIG. 2 is a diagram illustrating an example of a data structure of the conceivable question DB 120 of the first embodiment.

The conceivable question DB 120 stores a table 200 illustrated in FIG. 2, for example. The table 200 stores entries each including an ID 201 and a conceivable question 202. There is one entry for each conceivable question.

The ID 201 is a field for storing the ID of a conceivable question. The conceivable question 202 is a field for storing a text corresponding to a conceivable question. In the present embodiment, it is assumed that IDs are set in the order of questions.

FIG. 3 is a diagram illustrating an example of a data structure of the question candidate DB 121 of the first embodiment.

The question candidate DB 121 stores a table 300 illustrated in FIG. 3, for example. The table 300 stores entries each including a question count 301, a speech slot 302, an answer 303, and question candidate 304. There is one entry for each combination of a question count and a slot.

The question count 301 is a field for storing the number of questions asked to the user.

The speech slot 302 is a field for storing the ID of a slot. Wherein, a slot is a processing range of stream data. In the present embodiment, slots are defined based on a time elapsed from the start of speech. Specifically, slots are defined in units of 10 seconds from the start of speech (0 seconds). IDs are set to slots, and a slot whose ID is “1” corresponds to the voice during a period from 0 seconds to 10 seconds, and a slot whose ID is “2” corresponds to the voice during a period from 0 seconds to 20 seconds.

It is assumed that a sufficient number of slots are set to capture all the answers of the user. It should be noted that the processing range of stream data may be determined with reference to the start of speech.

The answer 303 is a field for storing the content of speech (answer) of the user within a predetermined time from the start of the speech. The answer of the user is stored in a text format in the answer 303.

The question candidate 304 is a field for storing a question candidate generated in consideration of the answer stored in the answer 303. The question candidate is stored in a text format in the question candidate 304.

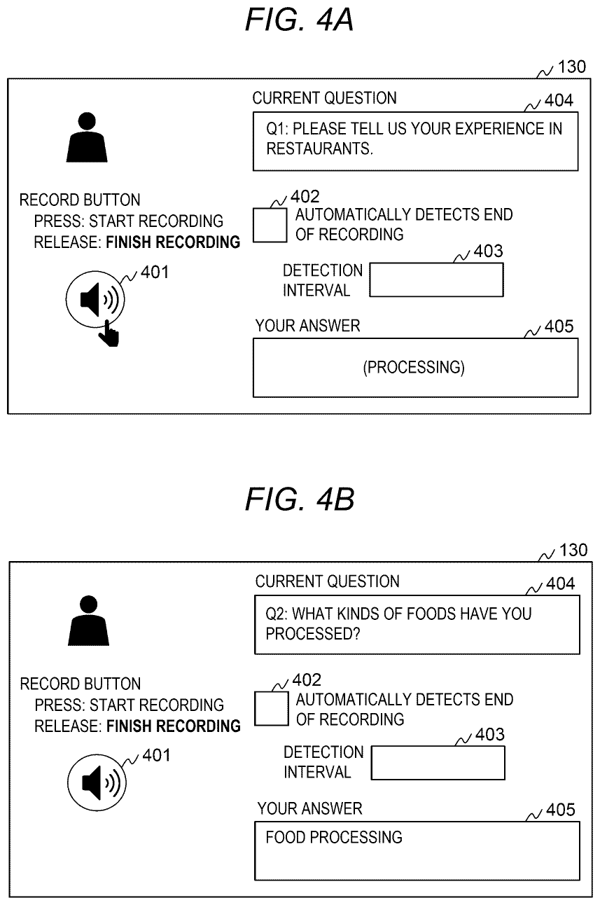

FIG. 4A and FIG. 4B are diagrams illustrating examples of the UI 130 of the embodiment.

The UI 130 includes a record button 401, a checkbox 402, an input field 403, a display field 404, and a display field 405.

The record button 401 is a button operated by the user to start a speech. In the present embodiment, while the record button 401 is being pressed, the UI 130 sequentially transmits stream data to the interview system 100. The stream data contains voice when the user speaks. When the user releases the record button 401, the UI 130 ends the transmission of stream data and transmits a speech end notification to the interview system 100.

The checkbox 402 is a box for specifying whether to enable or disable automatic detection of the end of recording. When the checkbox 402 is checked, the automatic detection of the end of recording is enabled, and the input field 403 for specifying a threshold value for detecting the end of recording is enabled. For example, when stream data with no voice is received continuously for equal to or greater than the threshold value set in the input field 403, the voice extraction unit 111 determines the end of recording. The voice extraction unit 111 may determine the end of recording using a silence detection model that determines whether a speech has been ended by using stream data as an input.

The display field 404 is a field for displaying a question. In the present embodiment, the UI 130 outputs a question as a voice and displays the question as a text in the display field 404. The display field 405 is a field for displaying an answer of the user.

FIG. 4A illustrates an example of the UI 130 in which a question is displayed, and the user inputs an answer to the question by pressing the record button 401. Until the input of the answer is ended, the display field 405 displays (Processing).

FIG. 4B illustrates an example of the UI 130 in which the user releases the record button 401, and an additional question is displayed. In this case, the display field 405 displays the answer to the question preceding the additional question displayed in the display field 404.

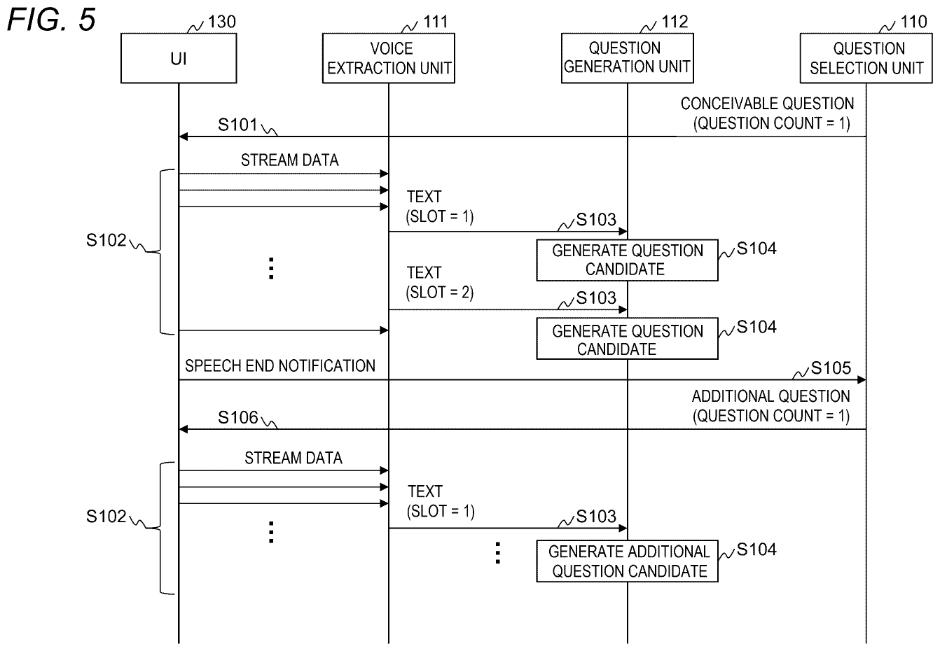

FIG. 5 is a sequence diagram explaining a processing flow of the system of the first embodiment.

Upon detecting the start of an interview, the question selection unit 110 sets the question count to “1” and transmits a conceivable question together with the question count to the UI 130 (step S101). Specifically, the question selection unit 110 transmits, to the UI 130, data for presenting a conceivable question to the user. The UI 130 presents the conceivable question to the user based on the data received.

When the user starts inputting an answer, the UI 130 transmits stream data together with the question count to the voice extraction unit 111 (step S102).

The voice extraction unit 111 stores the received stream data in the storage medium. The voice extraction unit 111 extracts voice from the stream data in a predetermined time range, converts the voice into a text, and transmits the text together with the question count and an slot ID to the question generation unit 112, at a predetermined timing (step S103). The voice extraction unit 111 repeats the processing of step S103 while receiving the stream data.

Upon receiving the text, the question generation unit 112 acquires a question candidate by inputting a prompt including the text to the natural language processing program 140, and stores the question candidate in the question candidate DB 121 (step S104). The question generation unit 112 repeats the processing of step S104 while receiving the stream data.

Upon detecting the end of the speech of the user, the UI 130 transmits a speech end notification to the question selection unit 110 (step S105).

Upon receiving the speech end notification, the question selection unit 110 selects an additional question from among question candidates and transmits the additional question to the UI 130 (step S106). Specifically, the question selection unit 110 transmits, to the UI 130, data for presenting an additional question to the user. The question selection unit 110 may generate an additional question by performing processing such as changing expression or translation on a selected question candidate. The UI 130 presents the additional question to the user based on the data received.

Thereafter, the processing of step S102, step S103, step S104, step S 105, and step S106 is repeatedly executed.

When the question count is greater than a predetermined value or generation of an additional question is not necessary, the question selection unit 110 selects a next conceivable question from the conceivable question DB 120 and executes the same processing. For example, when all conceivable questions are answered, the interview system 100 ends the interview.

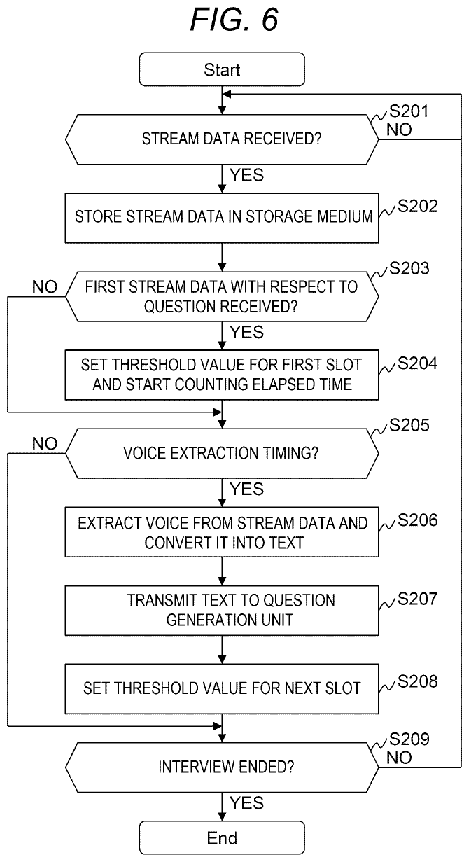

FIG. 6 is a flowchart explaining an example of the processing executed by the voice extraction unit 111 of the first embodiment.

Upon detecting the start of an interview, the voice extraction unit 111 starts the processing described below.

The voice extraction unit 111 monitors the reception of stream data (step S201).

When the stream data is received (step S201: YES), the voice extraction unit 111 stores the received stream data in the storage medium (step S202).

The voice extraction unit 111 determines whether the stream data is a first stream data for a question corresponding to the question count assigned to the stream data (step S203). For example, the voice extraction unit 111 determines whether an entry to which the same question count as the question count assigned to the stream data is set is registered in the question candidate DB 121.

When the stream data is not the first stream data for the question corresponding to the question count assigned to the stream data (step S203: NO), the voice extraction unit 111 proceeds to step S205.

When the stream data is the first stream data for the question corresponding to the question count assigned to the stream data (step S203: YES), the voice extraction unit 111 set a threshold value for the first slot and starts counting an elapsed time (step S204). Then, the voice extraction unit 111 proceeds to step S205. In the present embodiment, the threshold value for the first slot is 10 seconds.

In step S205, the voice extraction unit 111 determines whether it is a voice extraction timing (step S205). Specifically, the voice extraction unit 111 determines whether the elapsed time is greater than the threshold value. When the elapsed time is greater than the threshold value, it is determined to be a voice extraction timing. It should be noted that when stream data without voice is continuously received for a certain period, the voice extraction unit 111 may determine that input of an answer to a question has been ended and it is a voice extraction timing.

When it is not a voice extraction timing (step S205: NO), the voice extraction unit 111 proceeds to step S209.

When it is a voice extraction timing (step S205: YES), the voice extraction unit 111 extracts voice from the stream data received in a period corresponding to the slot and converts the voice into a text (step S206).

The voice extraction unit 111 registers the text in question candidate DB 121 (step S207). Specifically, the voice extraction unit 111 sets the text to the answer 303 of the entry in which the question count and the slot ID are stored in the question count 301 and the speech slot 302, respectively.

The voice extraction unit 111 transmits the text to the question generation unit 112 (step S207). It should be noted that a question count and a slot ID are assigned to a text.

The voice extraction unit 111 set a threshold value for the next slot (step S208), and then proceeds to step S209.

In step S209, the voice extraction unit 111 determines whether the interview has been ended (step S209).

When the interview has not been ended (step S209: NO), the voice extraction unit 111 returns to step S201. When the interview has been ended (step S209: YES), the voice extraction unit 111 ends the processing.

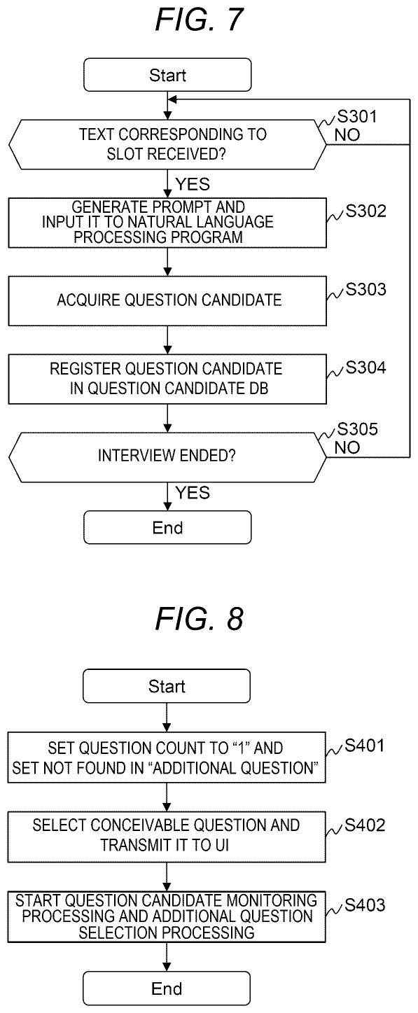

FIG. 7 is a flowchart explaining an example of the processing executed by the question generation unit 112 of the first embodiment.

Upon detecting the start of an interview, the question generation unit 112 starts the processing described below. The processing illustrated in FIG. 7 is executed by the number of slots. Conceivable execution methods include a method in which the processing illustrated in FIG. 7 is executed in parallel and a method in which a thread for executing the processing illustrated in FIG. 7 in the order of slots is generated and a next thread is generated after the processing illustrated in FIG. 7 is ended.

The question generation unit 112 monitors the reception of a text corresponding to each slot (step S301). The reception of a text corresponding to each slot can be determined based on the ID of the slot assigned to the text.

When a text corresponding to each slot is received (step S301: YES), the question generation unit 112 generates a prompt including the received text and inputs the prompt to the natural language processing program 140 (step S302).

The question generation unit 112 acquires a question candidate generated by the natural language processing program 140 (step S303), and registers the question candidate in the question candidate DB 121 (step S304). Specifically, the question generation unit 112 searches for an entry in which the question count and the slot ID assigned to the text are stored in the question count 301 and the speech slot 302, respectively, sets the received text to the answer 303 of the entry, and sets the question candidate to the question candidate 304 of the entry.

The question generation unit 112 determines whether the interview has been ended (step S305).

When the interview has not been ended (step S305: NO), the question generation unit 112 returns to step S301. When the interview has been ended (step S305: YES), the question generation unit 112 ends the processing.

FIG. 8 is a flowchart explaining an example of the processing executed by the question selection unit 110 of the first embodiment.

Upon detecting the start of an interview, the question selection unit 110 starts the processing described below.

The question selection unit 110 sets the question count to “1”, and sets an initial value “Not Found” in a variable “Additional Question” (step S401). At this time, the question selection unit 110 adds entries by the number of slots to the question candidate DB 121, sets “1” to the question count 301 of each of the entries added, and sets a slot ID in the speech slot 302 of each of the entries added.

The question selection unit 110 selects a conceivable question from the conceivable question DB 120 and transmits the conceivable question together with the question count to the UI 130 (step S402). Specifically, the question selection unit 110 transmits, to the UI 130, data for presenting a conceivable question to the user.

The question selection unit 110 starts question candidate monitoring processing and additional question selection processing (step S403).

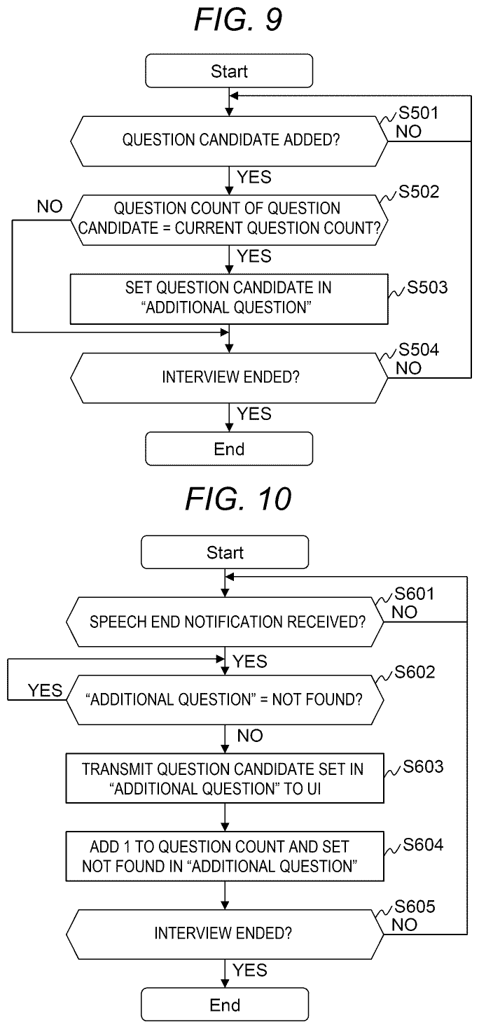

FIG. 9 is a flowchart explaining an example of the question candidate monitoring processing executed by the question selection unit 110 of the first embodiment.

The question selection unit 110 monitors whether a new question candidate has been added to the question candidate DB 121 (step S501).

When a new question candidate has been added to the question candidate DB 121 (S501: YES), the question selection unit 110 determines whether the question count of the new question candidate matches the current question count (step S502). Specifically, the question selection unit 110 determines whether the value of the question count 301 of the entry to which the question candidate is set matches the question count retained by the question selection unit 110.

When the question count of the new question candidate does not match the current question count (step S502: NO), the question selection unit 110 proceeds to step S504.

When the question count of the new question candidate matches the current question count (step S502: YES), the question selection unit 110 sets the added question candidate in the variable “Additional Question” (step S503). Then, the question selection unit 110 proceeds to step S504.

In step S504, the question selection unit 110 determines whether the interview has been ended (step S504).

When the interview has not been ended (step S504: NO), the question selection unit 110 returns to step S501. When the interview has been ended (step S504: YES), the question selection unit 110 ends the processing.

FIG. 10 is a flowchart explaining an example of the additional question selection processing executed by the question selection unit 110 of the first embodiment.

The question selection unit 110 monitors the reception of a speech end notification (step S601).

When a speech end notification is received (step S601: YES), the question selection unit 110 determines whether the variable “Additional Question”is “Not Found”(step S602).

When the variable “Additional Question” is “Not Found” (step S602: YES), the question selection unit 110 waits for a predetermined time and then returns to step S602.

When the variable “Additional Question” is not “Not Found” (step S602: NO), the question selection unit 110 transmits, to the UI 130, the question candidate set in the variable “Additional Question” as an additional question (step S603). Specifically, the question selection unit 110 transmits, to the UI 130, data for presenting an additional question to the user. At this time, the question selection unit 110 assigns the data with a value obtained by adding 1 to the current question count.

The question selection unit 110 adds 1 to the current question count, and sets “Not Found” in the variable “Additional Question” (step S604). At this time, the question selection unit 110 adds entries by the number of slots to the question candidate DB 121, sets an updated question count to the question count 301 of each of the entries, and sets a slot ID in the speech slot 302 of each of the entries.

The question selection unit 110 determines whether the interview has been ended (step S605).

When the interview has not been ended (step S605: NO), the question selection unit 110 returns to step S601. When the interview has been ended (step S605: YES), the question selection unit 110 ends the processing.

The interview system 100 of the first embodiment can flexibly generate question candidates in response to answers by using the natural language processing program 140. In addition, the interview system 100 can promptly present an additional question after the end of speech by generating question candidates from a part of the speech during the speech by a user, accumulating the question candidates, and selecting from the question candidates. Performing speculative execution processing for question candidates high-quality question candidates can be generated while promptness is ensured.

### Second Embodiment

In the second embodiment, the interview system 100 determines the validity of the content of an additional question.

The hardware configuration of a system of the second embodiment is the same as that of the first embodiment. The software configuration of the system of the second embodiment differs in that the interview system 100 retains NG setting information and NG case information and the question generation unit 112 manages a regeneration flag.

The NG setting information is information that defines undesirable contents or expressions of questions, for example, question candidates not in a question form. The NG case information is information for managing cases of questions with undesirable contents or expressions (NG cases).

The regeneration flag is a flag for controlling whether to regenerate a question candidate. The regeneration flag takes False indicating that a question candidate is not required to be generated again or True indicating that a question candidate is required to be generated again. The regeneration flag is set to False as an initial value.

The processing flow of the system of the second embodiment is the same as that of the first embodiment. The processing executed by the voice extraction unit 111 of the second embodiment is the same as that of the first embodiment. However, in the second embodiment, the voice extraction unit 111 sets the end of input of an answer as a voice extraction timing. In this case, all the contents of the speech are extracted.

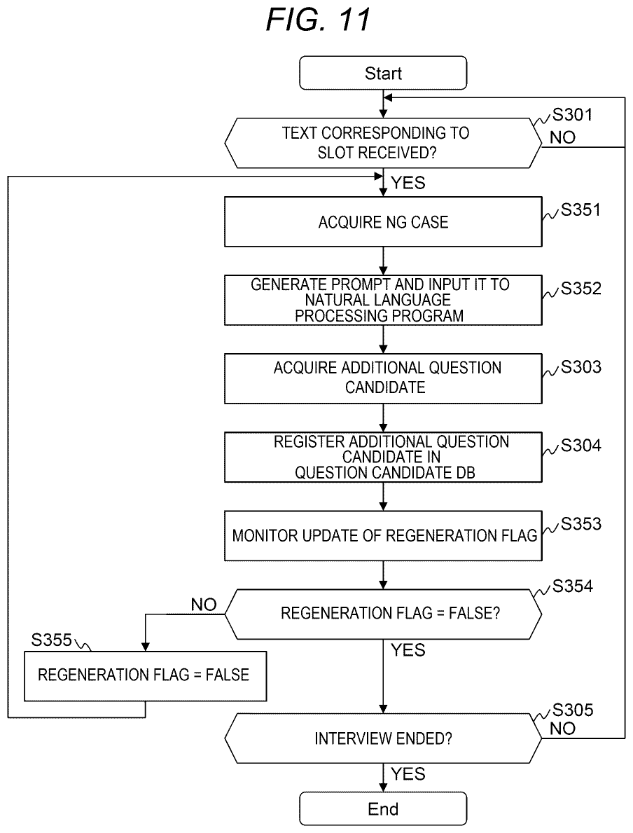

In the second embodiment, a part of the processing executed by the question generation unit 112 is different. FIG. 11 is a flowchart explaining an example of the processing executed by the question generation unit 112 of the second embodiment.

The question generation unit 112 monitors the reception of a text corresponding to each slot (step S301).

When a text corresponding to each slot is received (step S301: YES), the question generation unit 112 acquires an NG case from the NG case information (step S351).

The question generation unit 112 generates a prompt including the NG case and the received text and inputs the prompt to the natural language processing program 140 (step S352).

The question generation unit 112 acquires a question candidate generated by the natural language processing program 140 (step S303), and registers the question candidate in the question candidate DB 121 (step S304). Then, the question generation unit 112 monitors the update of the regeneration flag (step S353).

When the regeneration flag has been updated, the question generation unit 112 determines whether the updated regeneration flag is False (step S354).

When the updated regeneration flag is True (step S354: NO), the question generation unit 112 changes the regeneration flag to False (step S355) and then returns to step S351.

When the updated regeneration flag is False (step S354: YES), the question generation unit 112 determines whether the interview has been ended (step S305).

When the interview has not been ended (step S305: NO), the question generation unit 112 returns to step S301. When the interview has been ended (step S305: YES), the question generation unit 112 ends the processing.

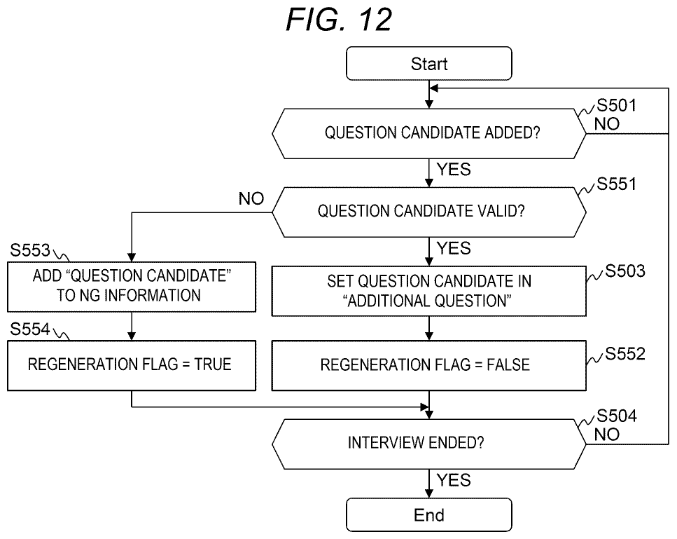

The additional question selection processing of the second embodiment is the same as that of the first embodiment. In the second embodiment, a part of the question candidate monitoring processing is different. FIG. 12 is a flowchart explaining an example of the question candidate monitoring processing executed by the question selection unit 110 of the second embodiment.

The question selection unit 110 monitors whether a new question candidate has been added to the question candidate DB 121 (step S501).

When a new question candidate has been added to the question candidate DB 121 (S501: YES), the question selection unit 110 refers to the NG setting information to determine whether the new question candidate is valid (step S551).

When the new question candidate is valid (step S551: YES), the question selection unit 110 sets the new question candidate in the variable “Additional Question” (step S503). The question selection unit 110 updates the regeneration flag to be False (step S552) and then returns to step S504.

When the new question candidate is not valid (step S551: NO), the question selection unit 110 adds the new question candidate to the NG case information (step S553). The question selection unit 110 updates the regeneration flag to be True (step S554) and then proceeds to step S504.

In step S504, the question selection unit 110 determines whether the interview has been ended (step S504).

When the interview has not been ended (step S504: NO), the question selection unit 110 returns to step S501. When the interview has been ended (step S504: YES), the question selection unit 110 ends the processing.

According to the second embodiment, the presentation of additional questions with inappropriate contents or expressions can be prevented by determining the validity of question candidates in advance.

### Third Embodiment

In the third embodiment, the interview system 100 stops the generation of a question candidate for a question for which input of an answer is ended.

The hardware configuration of a system of the third embodiment is the same as that of the first embodiment. The software configuration of the system of the third embodiment differs in that the question generation unit 112 manages a cancellation trigger. The cancellation trigger is a trigger for managing the question count of a question for which input of an answer is ended.

The processing flow of the system of the third embodiment is the same as that of the first embodiment. The processing executed by the voice extraction unit 111 of the third embodiment is the same as that of the first embodiment.

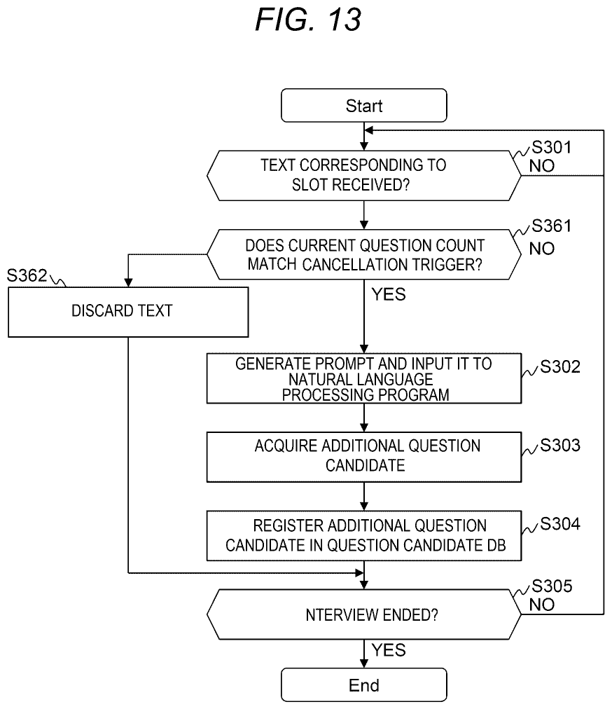

In the third embodiment, a part of the processing executed by the question generation unit 112 is different. FIG. 13 is a flowchart explaining an example of the processing executed by the question generation unit 112 of the third embodiment.

The question generation unit 112 monitors the reception of a text corresponding to each slot (step S301).

When a text corresponding to each slot is received (step S301: YES), the question generation unit 112 determines whether the current question count matches the cancellation trigger (step S361). Specifically, the question generation unit 112 determines whether the question count assigned to the text matches the cancellation trigger.

When the current question count matches the cancellation trigger (step S361: YES), the question generation unit 112 discards the text (step S362) and proceeds to step S304.

When the current question count does not match the cancellation trigger (step S361: NO), the question generation unit 112 generates a prompt including the received text and inputs the prompt to the natural language processing program 140 (step S302).

The question generation unit 112 acquires a question candidate generated by the natural language processing program 140 (step S303), and registers the question candidate in the question candidate DB 121 (step S304). Then, the question generation unit 112 proceeds to step S305.

In step S305, the question generation unit 112 determines whether the interview has been ended (step S305).

When the interview has not been ended (step S305: NO), the question generation unit 112 returns to step S301. When the interview has been ended (step S305: YES), the question generation unit 112 ends the processing.

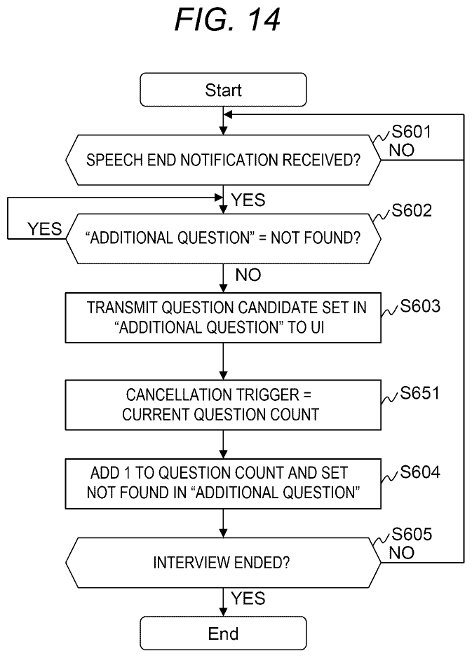

The question candidate monitoring processing of third embodiment is the same as that of the first embodiment. In the third embodiment, a part of the additional question selection processing is different. FIG. 14 is a flowchart explaining an example of the additional question selection processing executed by the question selection unit 110 of the third embodiment.

The question selection unit 110 monitors the reception of a speech end notification (step S601).

When a speech end notification is received (step S601: YES), the question selection unit 110 determines whether the variable “Additional Question”is “Not Found”(step S602).

When the variable “Additional Question” is “Not Found” (step S602: YES), the question selection unit 110 waits for a predetermined time and then returns to step S602.

When the variable “Additional Question” is not “Not Found” (step S602: NO), the question selection unit 110 transmits, to the UI 130, the question candidate added to the variable “Additional Question”as an additional question (step S603).

The question selection unit 110 sets the current question count to the cancellation trigger (step S651).

The question selection unit 110 adds 1 to the current question count, and sets “Not Found” in the variable “Additional Question”(step S604).

The question selection unit 110 determines whether the interview has been ended (step S605).

When the interview has not been ended (step S605: NO), the question selection unit 110 returns to step S601. When the interview has been ended (step S605: YES), the question selection unit 110 ends the processing.

According to the third embodiment, the interview system 100 can prevent the generation of a question candidate for a question that has already been answered. As a result, it is expected that the amount of resources used and the cost required to generate question candidates can be reduced.

### Fourth Embodiment

In the fourth embodiment, the interview system 100 includes a question candidate selected as an additional question in a prompt.

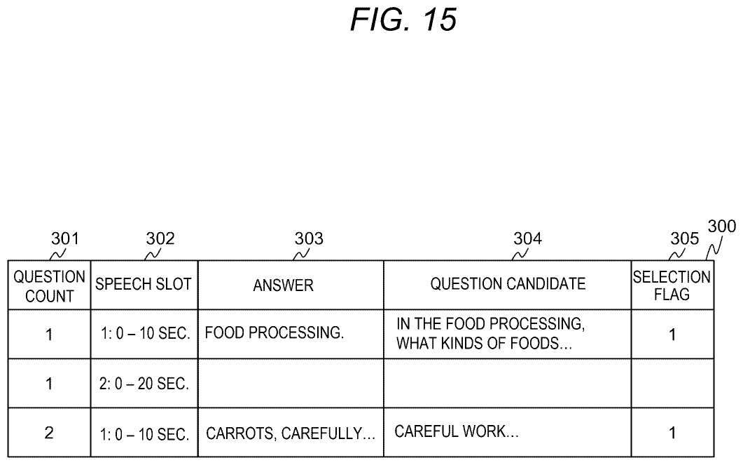

The hardware configuration and the software configuration of a system of the fourth embodiment are the same as those of the first embodiment. However, the fourth embodiment differs from the first embodiment in the data structure of the question candidate DB 121. FIG. 15 is a diagram illustrating an example of the data structure of the question candidate DB 121 of the fourth embodiment.

Entries stored in the table 300 newly include a selection flag 305. The selection flag 305 is a field for storing a flag that indicates whether a question candidate has been selected as an additional question. When a question candidate has not been selected as an additional question, “0” is set. When a question candidate has been selected as an additional question, “1” is set. At a time when a question candidate is generated, the selection flag 305 is set to “0”. The interview system 100 prevents a question candidate whose selection flag 305 is set to “0” from being used in subsequent processing. It should be noted that when input of an answer to the current question is ended, the interview system 100 may delete entries whose selection flag 305 is empty and entries whose selection flag 305 is “0”. As a result the data amount of the storage medium can be effectively used.

The processing flow of the system of the fourth embodiment is the same as that of the first embodiment. The processing executed by the voice extraction unit 111 of the fourth embodiment is the same as that of the first embodiment.

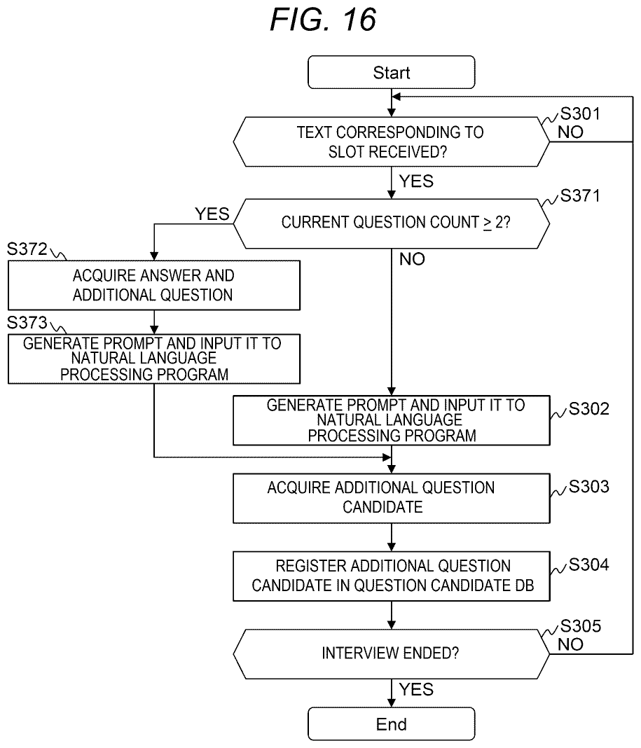

In the fourth embodiment, a part of the processing executed by the question generation unit 112 is different. FIG. 16 is a flowchart explaining an example of the processing executed by the question generation unit 112 of the fourth embodiment.

The question generation unit 112 monitors the reception of a text corresponding to each slot (step S301).

When a text corresponding to each slot is received (step S301: YES), the question generation unit 112 determines whether the current question count is 2 or greater (step S371). Specifically, the question generation unit 112 determines whether the question count assigned to the text is 2 or greater.

When the current question count is 1 (step S371: NO), the question generation unit 112 generates a prompt including the received text and inputs the prompt to the natural language processing program 140 (step S302). Then, the question generation unit 112 proceeds to step S303.

When the current question count is 2 or greater (step S371: YES), the question generation unit 112 acquires an answer and an additional question in the previous question count from the question candidate DB 121 (step S372). Specifically, the question generation unit 112 searches for an entry in which a question count immediately preceding the current question count is set in the question count 301 and the selection flag 305 is “1”. The question generation unit 112 acquires the texts stored in the answer 303 and the question candidate 304 of the searched entry. The question generation unit 112 may acquire all answers and additional questions preceding the current question count.

The question generation unit 112 generates a prompt including the acquired additional question and the acquired answer as well as the received text, and inputs the prompt to the natural language processing program 140 (step S373). Then, the question generation unit 112 proceeds to step S303.

The question generation unit 112 acquires a question candidate generated by the natural language processing program 140 (step S303), and registers the question candidate in the question candidate DB 121 (step S304).

The question generation unit 112 determines whether the interview has been ended (step S305).

When the interview has not been ended (step S305: NO), the question generation unit 112 returns to step S301. When the interview has been ended (step S305: YES), the question generation unit 112 ends the processing.

The question candidate monitoring processing of the fourth embodiment is the same as that of the first embodiment. The additional question selection processing of the fourth embodiment is the same as that of the first embodiment, except that a part of the processing content in step S603 is different. Specifically, the question selection unit 110 sets “1” to the selection flag 305 of the entry corresponding to the question candidate transmitted as an additional question.

According to the fourth embodiment, an additional question output in the past and an answer used to generate the additional question are included in a prompt, whereby the natural language processing program 140 can generate a high-quality question candidate.

### Fifth Embodiment

In the fifth embodiment, the interview system 100 determines the validity of the content of an additional question.

The hardware configuration of a system of the fifth embodiment is the same as that of the first embodiment. The software configuration of the system of the fifth embodiment differs in that the interview system 100 retains NG setting information. The NG setting information is information that defines undesirable contents or expressions of questions, for example, question candidates not in a question form.

The processing flow of the system of the fifth embodiment is the same as that of the first embodiment. The processing executed by the voice extraction unit 111 and the question generation unit 112 of the fifth embodiment are the same as those of the first embodiment.

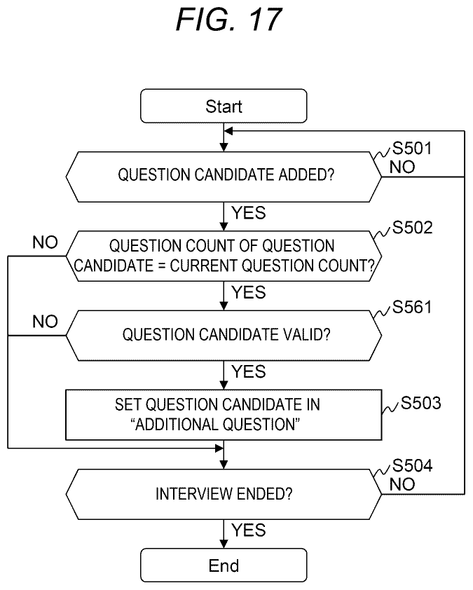

The additional question selection processing of the fifth embodiment is the same as that of the first embodiment. In the fifth embodiment, a part of the question candidate monitoring processing is different. FIG. 17 is a flowchart explaining an example of the question candidate monitoring processing executed by the question selection unit 110 of the fifth embodiment.

The question selection unit 110 monitors whether a new question candidate has been added to the question candidate DB 121 (step S501).

When a new question candidate has been added to the question candidate DB 121 (S501: YES), the question selection unit 110 determines whether the question count of the new question candidate matches the current question count (step S502).

When the question count of the new question candidate does not match the current question count (step S502: NO), the question selection unit 110 proceeds to step S504.

When the question count of the new question candidate matches the current question count (step S502: YES), the question selection unit 110 refers to the NG setting information to determine whether the new question candidate is valid (step S561).

When the new question candidate is determined to be not valid (step S561: NO), the question selection unit 110 proceeds to step S504.

When the new question candidate is determined to be valid (step S561: YES), the question selection unit 110 sets the new question candidate in the variable “Additional Question” (step S503). Then, the question selection unit 110 proceeds to step S504.

In step S504, the question selection unit 110 determines whether the interview has been ended (step S504).

When the interview has not been ended (step S504: NO), the question selection unit 110 returns to step S501. When the interview has been ended (step S504: YES), the question selection unit 110 ends the processing.

According to the fifth embodiment, the presentation of additional questions with inappropriate contents or expressions can be prevented by determining the validity of question candidates in advance. In the fifth embodiment, a high-quality question candidate is expected to be generated by using a voice extraction result of a subsequent slot, Thus, even when a question candidate with an inappropriate content or expression is generated, regeneration of a question candidate is not performed. As a result, the cost for regenerating a question candidate can be reduced, and an additional question can be presented promptly after the end of speech.

### Sixth Embodiment

In the sixth embodiment, the interview system 100 selects an additional question based on an answer of a user.

The hardware configuration and the software configuration of a system of the sixth embodiment are the same as those of the first embodiment.

The processing flow of the system of the sixth embodiment is the same as that of the first embodiment. The processing executed by the voice extraction unit 111 and the question generation unit 112 of the sixth embodiment are the same as those of the first embodiment. The question candidate monitoring processing of the sixth embodiment is the same as that of the first embodiment.

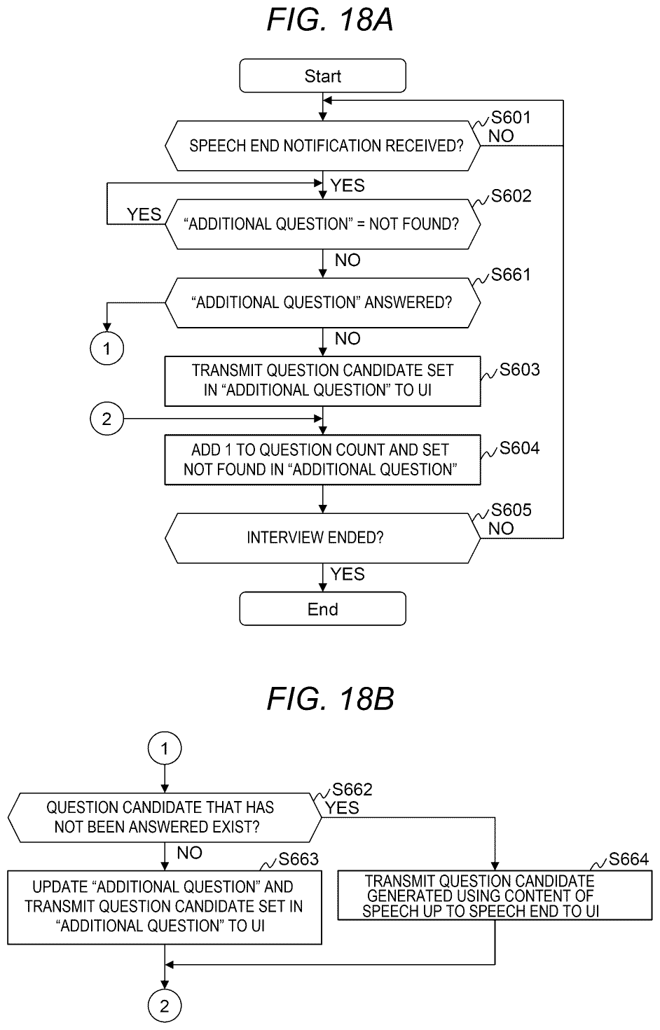

In the sixth embodiment, the additional question selection processing is different from that of the first embodiment. FIG. 18A and FIG. 18B are flowcharts explaining examples of the additional question selection processing executed by the question selection unit 110 of the sixth embodiment.

The question selection unit 110 monitors the reception of a speech end notification (step S601).

When a speech end notification is received (step S601: YES), the question selection unit 110 determines whether the variable “Additional Question”is “Not Found”(step S602).

When the variable “Additional Question” is “Not Found” (step S602: YES), the question selection unit 110 waits for a predetermined time and then returns to step S602.

When the variable “Additional Question” is not “Not Found” (step S602: NO), the question selection unit 110 refers to the question candidate DB 121 to determine whether an answer to the question candidate set in the variable “Additional Question” has been obtained (step S661).

Specifically, the question selection unit 110 acquires the answer 303 of the entry in which the current question count is stored in the question count 301, and determines whether an answer to the question candidate has been obtained. For example, a method in which the question selection unit 110 make a determination by executing natural language processing is conceivable. The question selection unit 110 may generate a prompt including the question candidate set in the variable “Additional Question” and the answer obtained and including an instruction for determining whether the answer to the question candidate has been obtained, and transmit the prompt to the natural language processing program 140.

When the answer to the question candidate set in the variable “Additional Question” has not been obtained (step S661: NO), the question selection unit 110 transmits, to the UI 130, the question candidate set in the variable “Additional Question” as an additional question (step S603). Then, the question selection unit 110 proceeds to step S604.

When the answer to the question candidate set in the variable “Additional Question” has been obtained (step S661: YES), the question selection unit 110 determines whether there is any question candidate that has not been answered among question candidates with the current question count (step S662).

Specifically, the question selection unit 110 acquires the answer 303 and the question candidate 304 of entries in which the current question count is stored in the question count 301, and determines whether there is any question candidate that has not been answered. For example, a method in which the question selection unit 110 make a determination by executing natural language processing is conceivable. The question selection unit 110 may generate a prompt including the answer obtained and the candidate question and including an instruction for determining whether there is any question candidate that has not been answered, and transmit the prompt to the natural language processing program 140.

When there is a question candidate that has not been answered among the question candidates with the current question count (step S662: YES), the question selection unit 110 sets one question candidate determined in the variable “Additional Question”, and transmits, to the UI 130, the question candidate set in the variable “Additional Question” as an additional question (step S663). Then, the question selection unit 110 proceeds to step S604. Here, the latest question candidate is set.

When there is not a question candidate that has not been answered among the question candidates with the current question count (step S662: NO), the question selection unit 110 waits for the generation of a question candidate to be generated using the content of speech up to the end of the speech, and transmits, to the UI 130, the question candidate set in the variable “Additional Question” as an additional question (step S664). Then, the question selection unit 110 proceeds to step S604. For example, the question selection unit 110 waits until a predetermined time elapses after receiving a speech end notification.

In step S604, the question selection unit 110 adds 1 to the current question count, and sets “Not Found” in the variable “Additional Question”(step S604).

The question selection unit 110 determines whether the interview has been ended (step S605).

When the interview has not been ended (step S605: NO), the question selection unit 110 returns to step S601. When the interview has been ended (step S605: YES), the question selection unit 110 ends the processing.

According to the sixth embodiment, the interview system 100 can avoid presenting duplicate questions by selecting, as an additional question, a question candidate other than question candidates that have been answered.

It should be noted that the invention is not limited to the above-described embodiments, but includes various modification examples. For example, the above-described embodiments have described the components in detail so as to explain the invention in an easy-to-understand manner, and the invention is not necessarily limited to a configuration including all the components described. Further, for a part of the components of each embodiment, the components of another embodiment can be added, deleted, or replaced.

In addition, a part or all of the respective components, functions, processing units, processing means, and the like described above may be implemented with hardware, for example, by being designed as an integrated circuit. Alternatively, the invention can be realized by program codes of software that implements the functions of the embodiments. In this case, a storage medium in which the program codes are recorded is provided to a computer, and a processor provided in the computer reads out the program codes stored in the storage medium. In this case, the program codes read out from the storage medium implement the functions of the above-described embodiments, and thus the program codes themselves and the storage medium storing the program codes constitute the invention. As the storage medium for supplying such program codes, for example, a flexible disk, a CD-ROM, a DVD-ROM, a hard disk, a solid state drive (SSD), an optical disk, a magnetic optical disk, a CD-R, a magnetic tape, a non-volatile memory card, and a ROM are used.

The program codes implementing the functions described in the present embodiment can be implemented in a wide range of program or script languages such as assembler, C/C++, perl, Shell, PHP, Python, and Java (registered trademark), for example.

Furthermore, the program codes of the software that implements the functions of the embodiments may be distributed via a network and stored in storage means such as a hard disk of a computer or a memory or a storage medium such as a CD-RW or a CD-R, and a processor provided in the computer may read out and execute the program codes stored in the storage means or the storage medium.

In the above-described embodiments, the control lines and the information lines that are considered to be necessary for description are indicated, and not all the control lines and the information lines on a product are necessarily indicated. All the components may be connected to each other.

What is claimed is:

1. A computer system comprising:
a processor; and
a storage medium connected to the processor,
the processor being configured to:
output output data for presenting a first question to a user,
sequentially receive first stream data including an answer to the first question from the user;
execute speculative execution processing for first question candidate generation at least one time during reception of the first stream data;
generate a second question based on at least one first question candidate generated by the speculative execution processing for the first question candidate generation when input of the answer to the first question is ended;
output output data for presenting the second question to the user;
generate, in the speculative execution processing for the first question candidate generation, a first prompt that causes a natural language processing program to execute generation of the first question candidate in consideration of the answer included in the first stream data received;
input the first prompt to the natural language processing program; and
store the first question candidate generated by the natural language processing program in the storage medium.

2. The computer system according to claim 1, wherein
the first stream data is voice data or video data, and
in the speculative execution processing for the first question candidate generation, the processor extracts voice of the user included in the first stream data received, converts the voice into a text, and generates the first prompt including the text.

3. The computer system according to claim 2, wherein
in the speculative execution processing for the first question candidate generation, the processor extracts voice of the user included in the first stream data in a predetermined time range of the first stream data received, and
the predetermined time range is a period determined based on a predetermined standard from a start of input of the answer to the first question.

4. The computer system according to claim 2, wherein when the processor continuously receives the first stream data including no voice of the user for a predetermined period, the processor determines that input of the answer to the first question has been ended.

5. The computer system according to claim 1, wherein when the processor detects an end of input of the answer to the first question, the processor terminates the speculative execution process for the first question candidate generation.

6. The computer system according to claim 1, wherein
the processor
sequentially receives second stream data including an answer to the second question from the user,
executes speculative execution processing for second question candidate generation at least one time during reception of the second stream data,
generates a third question based on at least one second question candidate generated by the speculative execution processing for the second question candidate generation when input of the answer to the second question is ended,
outputs output data for presenting the third question to the user,
generates, in the speculative execution processing for the second question candidate generation, a second prompt that causes the natural language processing program to execute generation of the second question candidate in consideration of the first question and the answer to the first question as well as the second question and the answer included in the second stream data received,
inputs the second prompt to the natural language processing program, and
stores the second question candidate generated by the natural language processing program in the storage medium.

7. The computer system according to claim 1, wherein
the speculative execution processing for the first question candidate generation is executed a plurality of times, and
the processor selects a latest first question candidates from a plurality of first question candidates, and generates the second question based on the latest first question candidates.

8. The computer system according to claim 1, wherein
in the speculative execution processing for the first question candidate generation, the processor records, in the storage medium, data in which the answer included in the first stream data received and the first question candidate are associated with each other, and
the processor executes:
when new data is recorded in the storage medium, determining whether the first question candidate included in the new data is valid;
when the first question candidate included in the new data is valid, setting the first question candidate included in the new data as an output candidate; and
when input of the answer to the first question is ended, generating the second question based on the first question candidate set as the output candidate.

9. The computer system according to claim 1, wherein
in the speculative execution processing for the first question candidate generation, the processor records, in the storage medium, data in which the answer included in the first stream data received and the first question candidate are associated with each other, and
the processor executes:
when new data is recorded in the storage medium, determining whether the first question candidate included in the new data has been answered based on a plurality of pieces of data recorded in the storage mediuma;
when the first question candidate included in the new data has not been answered, setting the first question candidate included in the new data as an output candidate;
when the first question candidate included in the new data has been answered, selecting the first question candidate that has not been answered from other pieces of data to be set as an output candidate, and
when input of the answer to the first question is ended, generating the second question based on the first question candidate set as the output candidate.

10. The computer system according to claim 1, wherein
in the speculative execution processing for the first question candidate generation, the processor records, in the storage medium, data in which the answer included in the first stream data received and the first question candidate are associated with each other, and
the processor disable or delete the data including the first question candidate that is not used for generation of the second question.

11. A computer system comprising:
a processor; and
a storage medium connected to the processor,
the processor being configured to:
output output data for presenting a first question to a user;
receive answer data including an answer to the first question from the user;
generate a prompt that causes a natural language processing program to execute generation of a question candidate in consideration of the answer using the answer data;
input the prompt to the natural language processing program;
acquire the question candidate from the natural language processing program;
determine whether the question candidate is valid; and
when the question candidate is valid, generate a second question and output output data for presenting the second question to the user.

12. The computer system according to claim 11, wherein when the question candidate is not valid, the processor generates a new prompt inputs the new prompt to the natural language processing program, and acquires the question candidate from the natural language processing program.

13. The computer system according to claim 12, wherein
the processor execute
recording the question candidate determined to be invalid in the storage medium, and
generating the new prompt including the question candidate determined to be invalid.

14. A non-transitory computer-readable storage medium storing a program to be executed by a computer,
the computer comprising:
a processor; and
a storage medium connected to the processor,
the program causing the computer to execute:
outputting output data for presenting a first question to a user,
sequentially receiving stream data including an answer to the first question from the user;
executing speculative execution processing for question candidate generation at least one time during reception of the stream data;
generating a second question based on at least one question candidate generated by the speculative execution processing for the question candidate generation when input of the answer to the first question is ended; and
outputting output data for presenting the second question to the user,
wherein the speculative execution processing for the question candidate generation includes:
generating a prompt that causes a natural language processing program to execute generation of the question candidate in consideration of the answer included in the stream data received;
inputting the prompt to the natural language processing program; and
storing the question candidate generated by the natural language processing program in the storage medium.
